(19) United States
(12) Patent Application Publication
(10) Pub. No.: US 2006/0187595 A1
(43) Pub. Date: Aug. 24, 2006

(54) APPARATUS AND METHOD FOR CONTROLLING LEAKAGE CURRENT IN BIPOLAR ESD CLAMPING DEVICES

(75) Inventors: Alan B. Botula, Essex Junction, VT (US); Steven H. Voldman, South Burlington, VT (US)

Correspondence Address: CANTOR COLBURN LLP-IBM BURLINGTON, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 10/906,480

(22) Filed: Feb. 22, 2005

(51) Int. Cl. H02H 9/00

(52) U.S. Cl. 361/56

(57) ABSTRACT

An apparatus for controlling leakage current in an electrostatic discharge (ESD) clamping network of an integrated circuit includes a bipolar ESD protection circuit having a trigger device and at least one discharge device. A leakage disablement network is coupled to the ESD protection circuit, wherein the leakage disablement network is configured to limit leakage current through one or more of the trigger device and the at least one discharge device, in the absence of an ESD event.

### BACKGROUND

The present invention relates generally to electrostatic discharge (ESD) in integrated circuits, and, more particularly, to an apparatus and method for controlling leakage current in bipolar electrostatic discharge (ESD) power clamping devices using a leakage disablement network.

Electrostatic Discharge (ESD) events, which can occur both during and after manufacturing of an integrated circuit (IC), can cause substantial damage to the IC. ESD events have become particularly troublesome for complementary metal oxide semiconductor (CMOS) and bipolar complementary metal oxide semiconductor (BiCMOS) chips because of their low power requirements and extreme sensitivity. A significant factor contributing to this sensitivity to ESD is that the transistors of the circuits are formed from small regions of N-type materials, P-type materials, and thin gate oxides. When a transistor is exposed to an ESD event, the charge applied may cause an extremely high current flow to occur within the device, which in turn can cause permanent damage to the junctions, neighboring gate oxides, interconnects and/or other physical structures.

Because of this potential damage, on-chip ESD protection circuits for CMOS and BiCMOS chips have become commonplace. In general, such protection circuits are characterized by a high failure threshold, a small layout size and a low resistive/capacitive (RC) delay so as to allow high-speed applications. An ESD event within an IC can be caused by a static discharge occurring at one of the power lines or rails. In an effort to guard the circuit against damage from the static discharge, circuits referred to as ESD clamps are used. An effective ESD clamp will maintain the voltage at the power line to a value that is known to be safe for the operating circuits, and that will not interfere with the operating circuits under normal operating conditions.

An ESD clamp circuit is typically constructed between a positive power supply (e.g., VDD) and a ground plane, or a ground plane and a negative power supply (e.g., VSS). The primary purpose of the ESD clamp is to reduce the impedance between the rails VDD and VSS so as to reduce the impedance between the input pad and the VSS rail (i.e., discharge of current between the input to VSS), and to protect the power rails themselves from ESD events.

The continued consumer demand for increased speed in radio frequency (RF) devices has resulted in some unique challenges for providing ESD protection in these high-speed applications. For example, ESD power clamps in silicon germanium (SiGe) applications should ideally provide low power off states for wireless and RF applications (i.e., by minimizing leakage current dissipated therethrough) in order to minimize battery power loss, but at the same time still maintain a desired level of ESD protection. Unfortunately, existing circuit topologies that provide sufficient ESD protection do not also minimize the leakage state. Accordingly, it would be desirable to be able to provide customers with sufficient ESD protection while also minimizing leakage losses, particularly for applications where power consumption is of concern.

### SUMMARY

The foregoing discussed drawbacks and deficiencies of the prior art are overcome or alleviated by an apparatus for controlling leakage current in an electrostatic discharge (ESD) clamping network of an integrated circuit. In an exemplary embodiment, a bipolar ESD protection circuit includes a trigger device and at least one discharge device. A leakage disablement network is coupled to the ESD protection circuit, wherein the leakage disablement network is configured to limit leakage current through one or more of the trigger device and the at least one discharge device, in the absence of an ESD event.

In another embodiment, a method for controlling leakage current in a bipolar electrostatic discharge (ESD) protection circuit of an integrated circuit includes configuring a leakage disablement network with the ESD protection circuit. The leakage disablement network limits leakage current through one or more of a trigger device and at least one discharge device included in the ESD protection circuit, in the absence of an ESD event.

### BRIEF DESCRIPTION OF THE DRAWINGS

Referring to the exemplary drawings wherein like elements are numbered alike in the several Figures:

FIG. 1 is a schematic diagram of an existing configuration of a bipolar ESD clamp, including a trigger device and one or more clamping (discharge) devices;

FIG. 2 is a schematic diagram of an apparatus for implementing low leakage power clamping for an ESD clamp, including a first type (Type 1) of leakage disablement network configured in series between the power rail and the collector terminal of the trigger device;

FIG. 3 is a schematic diagram illustrating one possible implementation of the Type 1 leakage disablement network shown in FIG. 2;

FIG. 4 is a schematic diagram of an alternative embodiment of an apparatus for implementing low leakage power clamping for an ESD clamp, wherein a Type 1 leakage disablement network is configured in series between the bias resistor and the emitter terminal of the trigger device;

FIG. 5 is a schematic diagram illustrating one possible implementation of the Type 1 leakage disablement network shown in FIG. 4;

FIG. 6 is a schematic diagram illustrating an alternative embodiment of the apparatus of FIG. 2;

FIG. 7 is a schematic diagram of an apparatus for implementing low leakage power clamping for an ESD clamp, including a second type (Type 2) of leakage disablement network configured in series between the base terminal of the trigger device and the lower power rail;

FIG. 8 is a schematic diagram illustrating one possible implementation of the Type 2 leakage disablement network shown in FIG. 7;

FIG. 9 is a schematic diagram of an alternative embodiment of an apparatus for implementing low leakage power clamping for an ESD clamp, wherein a Type 2 leakage disablement network is configured between the base terminal of the trigger device and the bias resistor;

FIGS. 10 and 11 are schematic diagrams of a low leakage clamping apparatus using a Type 1 disablement network for each discharge device, in accordance with an alternative embodiment of the invention; and

FIG. 12 is a schematic diagram of a low leakage clamping apparatus using a Type 2 disablement network for each discharge device, in accordance with still an alternative embodiment of the invention.

### DETAILED DESCRIPTION

Disclosed herein is an apparatus and method for implementing a low leakage, silicon germanium electrostatic discharge (ESD) power clamping device for integrated circuits. Briefly stated, a bipolar ESD clamp is configured with a leakage disablement network that (depending on its particular location in the clamp circuit) provides a high impedance path during normal operating conditions (i.e., a steady-state, DC condition), and a low impedance path during an ESD event. Alternatively, the leakage disablement network may also be configured to provide a high impedance path during normal operating conditions, and a low impedance path during an ESD event, as described in more detail hereinafter.

Regardless of the specific circuit topology embodiment implemented, the leakage disablement network is configured to alleviate the flow of leakage current in the clamp during normal operating conditions, but without inhibiting the desired performance of the ESD protective functioning of the clamp. An additional advantage is realized as a result of the ability to keep the clamp from triggering inadvertently during a fast slew on the power supply, which is a common concern on purely slew-triggered devices. As the embodiments herein combine slew-based triggering with over-voltage triggering, the clamp will not turn on unless both conditions are present.

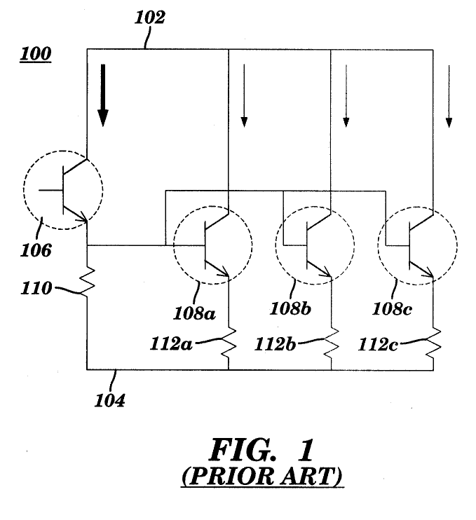

Referring initially to FIG. 1, there is shown a schematic diagram of an existing bipolar ESD clamp 100 configured between a pair of power rails 102, 104. As indicated previously, the power rails 102, 104 may be configured at VDD and ground potential, or at ground and VSS (negative potential), for example. The ESD clamp 100 is implemented in a Darlington configuration, including a bipolar trigger device 106 (e.g., an npn SiGe transistor) and one or more discharge (clamp) devices 108a-108c. The discharge devices 108a-108c may also be npn SiGe transistors. Moreover, the bipolar elements of the trigger device 106 and the discharge devices 108a-108c may be homojunction bipolar transistors (BJT) (e.g., silicon or germanium). They may also be heterojunction bipolar transistors (HBT) or double heterojunction bipolar transistors (DHBT), including materials such as gallium arsenide, silicon germanium, indium phosphide and silicon germanium carbon, for example.

The trigger device 106 is designed to have a lower collector to emitter breakdown voltage (BVCEO) than that of the discharge devices 108a-108c such that, upon detection of an ESD event, the trigger device 106 (upon reaching its BVCEO) will provide sufficient base current to the discharge devices 108a-108c, thereby allowing the discharge devices to facilitate the discharge of ESD current therethrough. In order to limit the amount of current flowing through the trigger device 106 and develop a bias voltage across the discharge transistors during an ESD event, a bias resistor 110 is placed in series between the emitter terminal of the trigger device 106 and power rail 104. In addition, each of the discharge devices 108a-108c has a ballast resistor 112a-112c in series with the emitter terminal thereof to provide emitter stability, voltage limitations, thermal stability and ESD stability.

During normal operating conditions (i.e., no ESD events), the ESD clamp 100 should be transparent to the operation of the circuitry it is designed to protect. However, one undesirable effect of the clamp circuitry is that the bipolar devices pass leakage current between the collector and emitter terminals thereof (shown by arrows in FIG. 1). In particular, because the base terminal of the trigger device 106 is left open, it represents the primary source of leakage current in the ESD clamp 100 (as indicated by the heavier arrow). As indicated above, for certain applications such as high speed RF and wireless communication circuitry, power leakage should be prevented to the extent possible. Thus, one way to pinch off the leakage current through the trigger device 106 would be to simply ground the base terminal thereof. However, as a result, the BVCEO of the trigger device 106 would be increased to a level that would prevent it from providing a desired level of ESD protection.

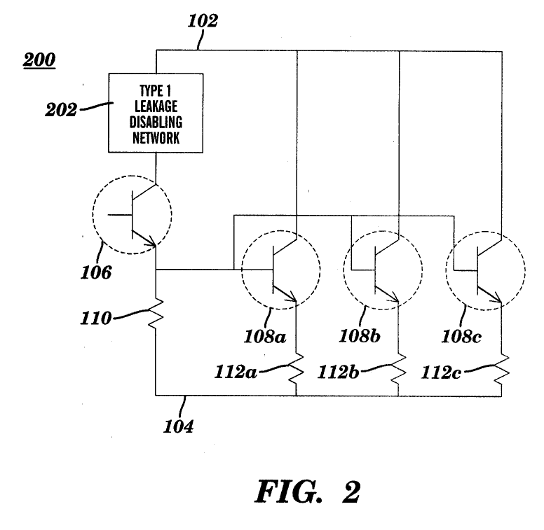

Therefore, in accordance with an embodiment of the invention, FIG. 2 illustrates an apparatus 200 for implementing low leakage power clamping for an ESD clamp. In the embodiment depicted, a leakage disablement network 202 is configured in series between the power rail 102 and the collector terminal of the trigger device 106. Furthermore, the leakage disablement network 202 of the embodiment of FIG. 2 is of a first type (Type 1) that is designed to provide a high impedance path during normal operating conditions to prevent leakage current through the trigger device 206. However, during an ESD event, the leakage disablement network 202 is “self-disabling” so as to provide a low impedance path therethrough, thus permitting the trigger device 206 to properly function at its designed BVCEO value.

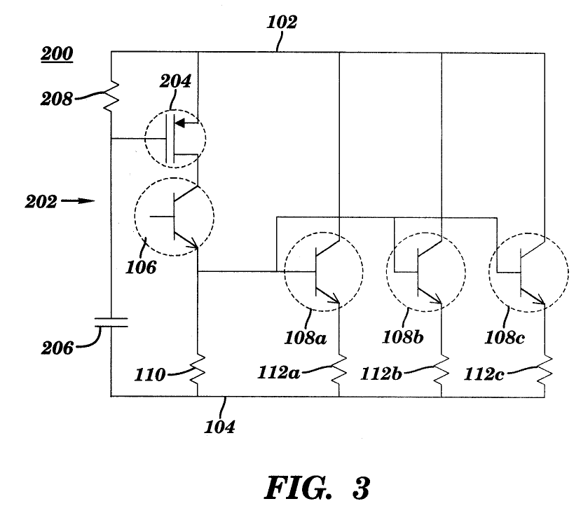

FIG. 3 illustrates one possible implementation of the leakage disablement network 202 shown in FIG. 2. As is shown, a p-type field effect transistor 204 (PFET) is arranged in series between the power rail 102 and the collector of the trigger device 106. The gate terminal of the PFET 204 is connected to one side of a capacitor 206, with the other side of capacitor 206 being coupled to the lower power rail 104. A resistor 208 is further connected between the upper power rail 102 and the capacitor 206.

During normal operating conditions, the capacitor 206 will be fully charged to the voltage between the power rails 102, 104. Accordingly, there is essentially no potential difference between gate and source terminals of the PFET 204, and thus the PFET 204 is in a non conductive state so as to result in a high impedance path through the trigger device 106. However, during an ESD event, the sudden spike in voltage across the power rails 102, 104 causes the capacitor 206 to begin charging to the higher ESD potential, which is immediately present across resistor 208. This condition therefore renders the PFET 204 conductive (i.e., providing a low impedance path), thereby permitting the trigger device 106 to operate in its designed breakdown mode for activating the discharge devices 108a-108c. It will be appreciated the RC time constant of the resistor/capacitor combination of the leakage disablement network 202 will be selected in a manner that permits the PFET 204 to be activated upon ESD detection.

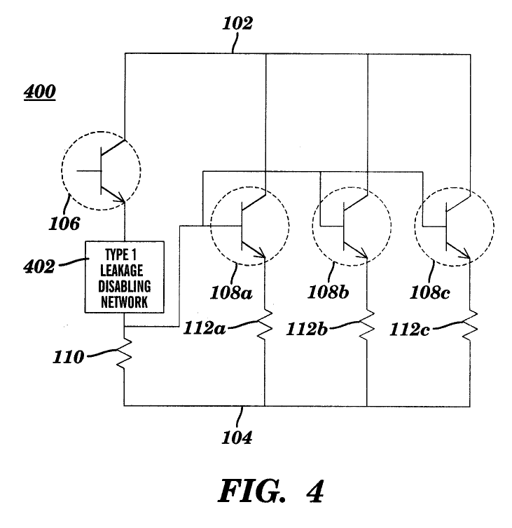

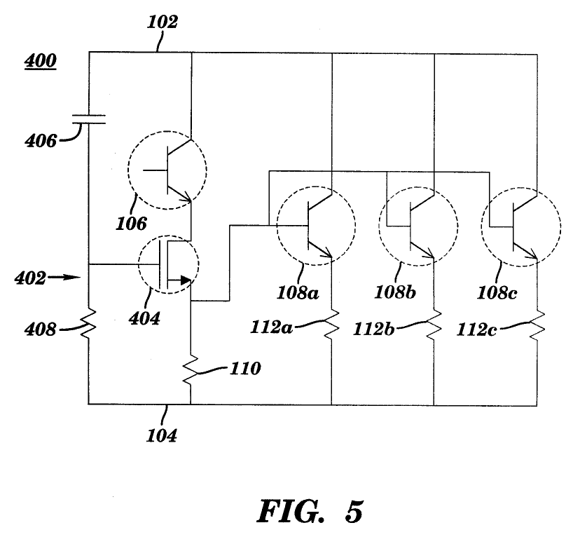

In addition to the particular location of the of the leakage disablement network 202 of the embodiments in FIGS. 2 and 3, other circuit topology locations are also contemplated. For example, FIG. 4 illustrates an alternative embodiment of an apparatus 400 for implementing low leakage power clamping for an ESD clamp, wherein the leakage disablement network 402 is configured in series between the bias resistor 110 and the emitter terminal of the trigger device 106. Again, the leakage disablement network 402 of the embodiment of FIG. 4 is also a Type 1 network, in that it is designed to provide a high impedance path during normal operating conditions and a low impedance path during an ESD event. Whereas the FIG. 3 implementation of network 202 utilizes a PFET device to realize the desired impedance qualities, a corresponding implementation of the network 402 of FIG. 4 would employ an NFET device 404 and capacitor 406/resistor 408 combination as shown in FIG. 5.

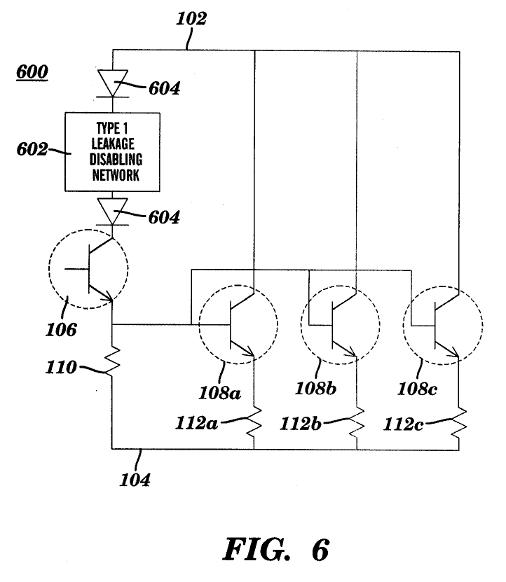

Referring now to FIG. 6, still an alternative embodiment of an apparatus 600 for implementing low leakage power clamping is shown, in which the Type 1 leakage disablement network 602 is again shown in series with the collector terminal of the trigger device 106, similar to FIG. 2. In addition, the embodiment of FIG. 6 allows for adjustably controlling the BVCEO of the trigger device 106 through the use of one or more diodes 604 configured in the collector path. Additional information regarding the use of level shifting devices for adjusting the breakdown voltage of ESD triggers may be found, for example, in U.S. Pat. No. 6,549,061 to Voldman, et al., assigned to the assignee of the present application, and the contents of which are incorporated by reference herein in their entirety.

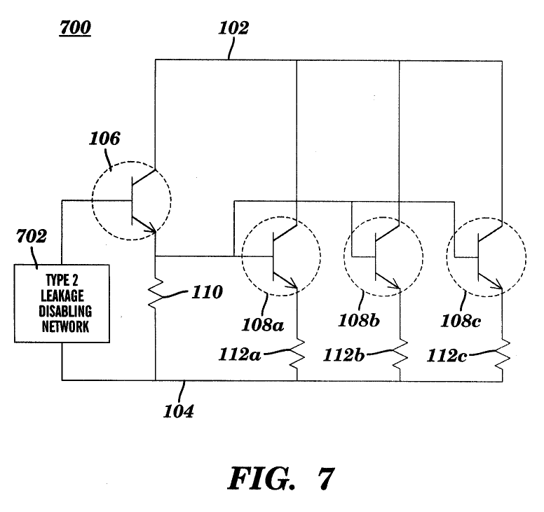

In addition to utilizing various leakage disablement network schemes within the collector and emitter paths of the trigger device 106 of the ESD clamp, the base terminal of the trigger device may also be configured with a leakage disablement network. However, in such a scheme, a second type (Type 2) of leakage disablement network is defined such that the network provides a low impedance path during normal operating conditions and a high impedance path during an ESD event. An example of a Type 2 leakage disablement network is illustrated in FIG. 7, in which the low leakage, power clamping apparatus 700 includes a Type 2 leakage disablement network 702 arranged in series between the base terminal of the trigger device 106 and the lower power rail 104.

In normal operation of the ESD clamp, it will be recalled that by coupling the base terminal of the trigger device 106 to ground, the leakage current therethrough may be significantly reduced. However, a permanent hard wire connection would also result in an increase in the breakdown voltage of the trigger device, which would negatively impact the ESD protection. Accordingly, the Type 2 leakage disablement network 702 provides a low impedance path to ground during normal operation, but is also self-disabling (i.e., provides a high impedance path for isolating the base terminal from ground) when an ESD event is sensed.

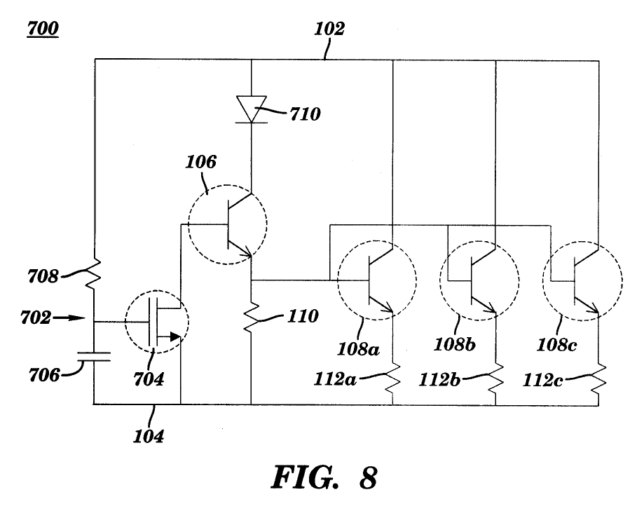

An exemplary implementation for the Type 2 leakage disablement network 702 is shown in FIG. 8. As can be seen, the leakage disablement network 702 includes an NFET device 704 configured between the base terminal of the trigger device 106 and the lower power rail 104. The gate terminal of the NFET 704 is connected between capacitor 706 and resistor 708. A diode 710 is also illustrated by way of example to depict the capability of selectively adjusting the breakdown voltage of the trigger device 106. During a normal operating condition, the supply voltage is stored across the capacitor 706, and thus NFET 704 will hold the base terminal of the trigger device 106 to ground so as to pinch off the leakage current through the trigger device 106. It should also pointed out that the particular embodiment shown in FIG. 8 is designed to provide ESD protection to the device when in an initial unpowered state. In other words, since there is no voltage across the capacitor 706 in an unpowered state, an ESD spike on the power rails will not instantaneously result in NFET 704 turning on (due to the uncharged capacitor 706). Accordingly, the base terminal of trigger device 106 initially remains isolated to maintain the proper BVCEO for ESD protection.

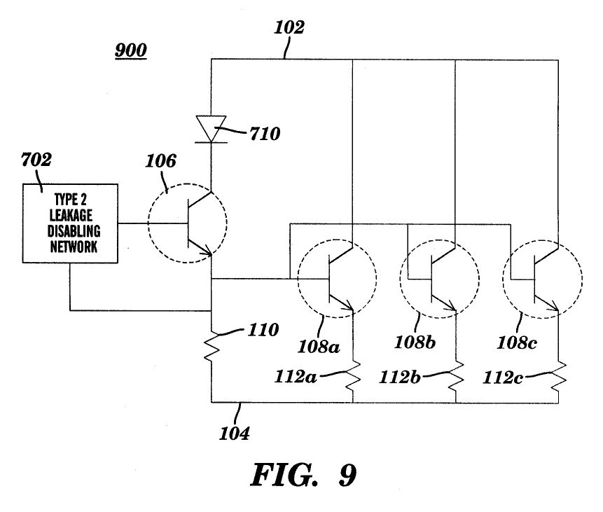

FIG. 9 illustrates another embodiment of a clamping apparatus 900 using the Type 2 leakage disablement network 702, wherein the network 702 may be configured between the base terminal of the trigger device 106 and the bias resistor 110. Again, the Type 2 leakage disablement network 702 provides a low impedance during a normal operating condition for controlling leakage current, while also providing a high impedance during an ESD event.

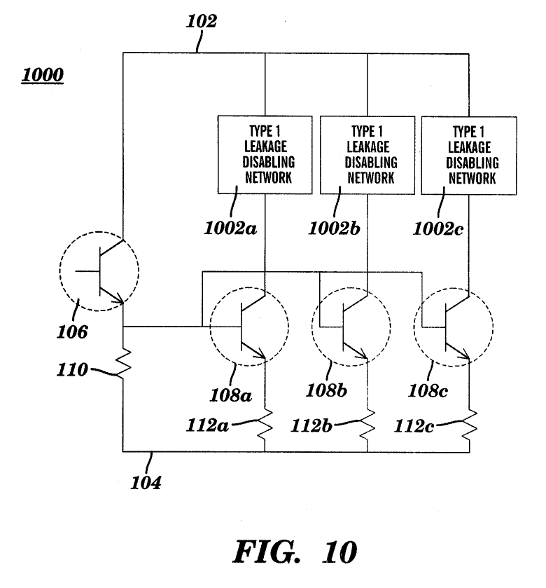

The leakage disablement network embodiments discussed to this point have been presented in the context of controlling leakage current through the trigger device. However, the same principles may also be applied to controlling leakage current through the one or more discharge devices 108a-108c. For example, FIG. 10 illustrates a clamping apparatus 1000 using a Type 1 disablement network 1002a, 1002b, 1002c for each associated discharge device 108a, 108b, 108c. Similar to the embodiment of FIG. 2, a Type 1 leakage disablement network included within the collector paths of the discharge devices provides a high impedance path to control leakage current during normal operation, but a low impedance path during an ESD event to allow the discharge devices to sink an appropriate amount of ESD current.

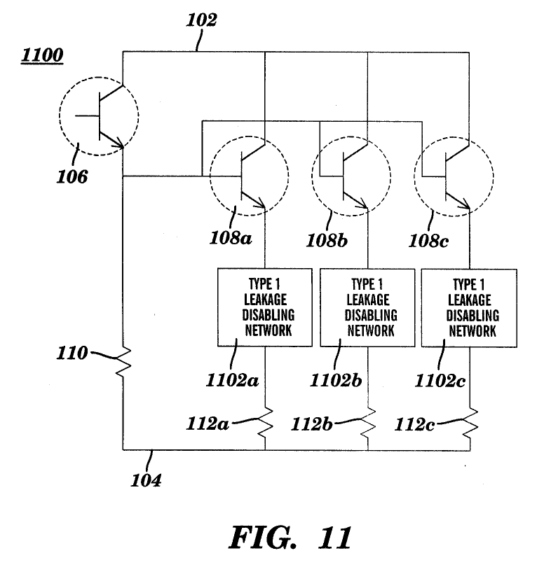

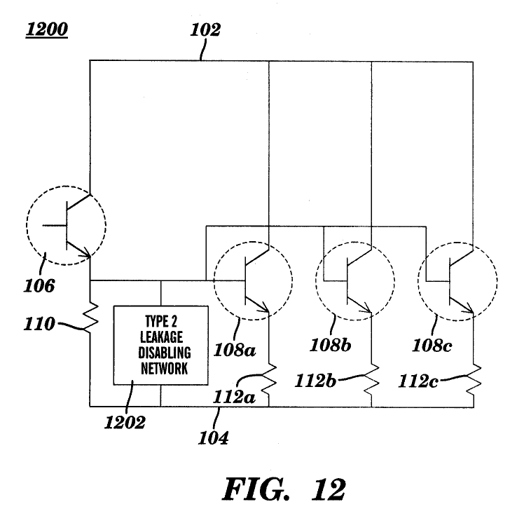

In the schematic diagram of FIG. 11, another embodiment of a clamping apparatus 1100 uses the Type 1 disablement networks 1002a, 1002b, 1002c in the emitter path of associated discharge devices 108a, 108b, 108c. Finally, FIG. 12 illustrates a further embodiment of an ESD clamping apparatus, in which a Type 2 disablement network is used in conjunction with the base terminals of the discharge devices. As shown in FIG. 12, the ESD clamping apparatus 1200 includes a Type 2 disablement network 1202 configured between a common base terminal of the discharge devices 108a, 108b, 108c.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for controlling leakage current in an electrostatic discharge (ESD) clamping network of an integrated circuit, comprising:
a bipolar ESD protection circuit including a trigger device and at least one discharge device; and
a leakage disablement network coupled to said ESD protection circuit;
wherein said leakage disablement network is configured to limit leakage current through one or more of said trigger device and said at least one discharge device in the absence of an ESD event.

2. The apparatus of claim 1, wherein said leakage disablement network is configured to provide a high impedance path during a normal operating condition and a low impedance path during an ESD event.

3. The apparatus of claim 2, wherein said leakage disablement network is configured within an emitter path of said trigger device.

4. The apparatus of claim 2, wherein said leakage disablement network is configured within a collector path of said trigger device.

5. The apparatus of claim 1, wherein said leakage disablement network is configured to provide a low impedance path during a normal operating condition and a high impedance path during an ESD event.

6. The apparatus of claim 5, wherein the leakage disablement network is coupled to a base terminal of said trigger device.

7. The apparatus of claim 1, wherein:
said leakage disablement network further comprises at least one of a first type network and a second type network;
said first type network is configured to provide a high impedance path during a normal operating condition and a low impedance path during an ESD event; and
said second type network is configured to provide a low impedance path during a normal operating condition and a high impedance path during an ESD event.

8. The apparatus of claim 7, wherein said first type network is configured within one of an emitter path and a collector path of said one or more of said trigger device and said at least one discharge device.

9. The apparatus of claim 8, wherein said second type network is coupled to a base path of said one or more of said trigger device and said at least one discharge device.

10. The apparatus of claim 1, wherein said bipolar ESD protection circuit further comprises at least one or more of:
a homojunction bipolar junction device comprising one of silicon or germanium;
a heterojunction bipolar junction device comprising one or more of gallium arsenide, silicon germanium, indium phosphide and silicon germanium carbon; and
a double heterojunction bipolar junction device comprising one or more of gallium arsenide, silicon germanium, indium phosphide and silicon germanium carbon.

11. A method for controlling leakage current in a bipolar electrostatic discharge (ESD) protection circuit of an integrated circuit, the method comprising:
configuring a leakage disablement network with the ESD protection circuit;
wherein said leakage disablement network limits leakage current through one or more of a trigger device and at least one discharge device included in the ESD protection circuit, in the absence of an ESD event.

12. The method of claim 11, wherein said leakage disablement network is configured to provide a high impedance path during a normal operating condition and a low impedance path during an ESD event.

13. The method of claim 12, wherein said leakage disablement network is configured within an emitter path of said trigger device.

14. The method of claim 12, wherein said leakage disablement network is configured within a collector path of said trigger device.

15. The method of claim 11, wherein said leakage disablement network is configured to provide a low impedance path during a normal operating condition and a high impedance path during an ESD event.

16. The method of claim 15, wherein the leakage disablement network is coupled to a base terminal of said trigger device.

17. The method of claim 11, wherein:
said leakage disablement network further comprises at least one of a first type network and a second type network;
said first type network is configured to provide a high impedance path during a normal operating condition and a low impedance path during an ESD event; and
said second type network is configured to provide a low impedance path during a normal operating condition and a high impedance path during an ESD event.

18. The method of claim 17, wherein said first type network is configured within one of an emitter path and a collector path of said one or more of said trigger device and said at least one discharge device.

19. The method of claim 18, wherein said second type network is coupled to a base path of said one or more of said trigger device and said at least one discharge device.

20. The method of claim 11, wherein said bipolar ESD protection circuit further comprises at least one or more of:
a homojunction bipolar junction device comprising one of silicon or germanium;
a heterojunction bipolar junction device comprising one or more of gallium arsenide, silicon germanium, indium phosphide and silicon germanium carbon; and
a double heterojunction bipolar junction device comprising one or more of gallium arsenide, silicon germanium, indium phosphide and silicon germanium carbon.
